(19) United States
(12) Patent Application Publication
(10) Pub. No.: US 2025/0062475 A1
(43) Pub. Date: Feb. 20, 2025

(54) MODULAR BATTERY CELL BLOCKS FOR MULTI-CELL ENERGY STORAGE SYSTEM

(71) Applicant: GM GLOBAL TECHNOLOGY OPERATIONS LLC, Detroit, MI (US)

(72) Inventors: Derek F. Lahr, Howell, MI (US); Xiaoling Chen, Sterling Heights, MI (US); Arun M. Joshi, Troy, MI (US); Madhusudan Raghavan, West Bloomfield, MI (US); Liang Xi, Northville, MI (US); Masoud Mohammad Pour, Novi, MI (US)

(73) Assignee: GM GLOBAL TECHNOLOGY OPERATIONS LLC, Detroit, MI (US)

(21) Appl. No.: 18/449,163

(22) Filed: Aug. 14, 2023

(51) Int. Cl. H01M 50/26; H01M 10/625; H01M 10/653; H01M 10/6554; H01M 10/658; H01M 50/204; H01M 50/249; H01M 50/30

(52) U.S. Cl. CPC H01M 50/26; H01M 10/625; H01M 10/653; H01M 10/6554; H01M 10/658; H01M 50/204; H01M 50/249; H01M 50/30; H01M 2220/20

(57) ABSTRACT

A modular multi-cell rechargeable energy storage system (RESS) includes a RESS enclosure surrounded by an external environment and having an enclosure tray and an enclosure cover. The RESS also includes a plurality of battery cell blocks arranged in the RESS enclosure. Each battery cell block includes a cell case including a cell vent and at least one electrically insulated structural connector configured to link the cell case with an adjacent battery cell block. Each battery cell block also includes a thermal mitigation barrier (TMB) segment fixed to the cell case and configured to contact the adjacent battery cell block. Each battery cell block additionally includes a thermal insulator configured to line the cell vent. Furthermore, each battery cell block includes a bus bar segment configured to interconnect with a bus bar segment of the adjacent battery cell block.

### INTRODUCTION

The present disclosure relates to modular battery cell blocks for a multi-cell rechargeable energy storage system and structure thereof.

Batteries may be broadly classified into primary and secondary batteries. Primary batteries, also referred to as disposable batteries, are intended to be used until depleted, after which they are simply replaced with new batteries. Secondary batteries, more commonly referred to as rechargeable batteries, employ specific chemistries permitting such batteries to be repeatedly recharged and reused, therefore offering economic, environmental, and ease-of-use benefits compared to disposable batteries. A multi-cell rechargeable energy storage system (RESS) typically includes a battery cell array, such as a battery module, pack, etc., plurality of secondary battery cells in relatively close proximity to one another.

A large RESS may be used to store electrical energy for future use and as a buffer between peak power generation and peak system loads, such as in stationary energy storage systems and electric vehicles (EVs). To meet design objectives of charging rates, peak output power, and capacity, secondary batteries may be organized into battery systems or arrays with battery cells connected in parallel and/or in series and enclosed into battery module and/or pack housings. Such an RESS typically includes an enclosure for housing individual battery cells, and various internal components, such as a cold plate, thermal insulation elements, an interconnect board (ICB) for linking the battery cells, sensing and communication components, and an electrical busbar establishing connections therebetween.

### SUMMARY

A modular multi-cell rechargeable energy storage system (RESS) includes a RESS enclosure surrounded by an external environment and having an enclosure tray and an enclosure cover. The RESS also includes a plurality of battery cell blocks arranged in the RESS enclosure. Each battery cell block includes a cell case including a cell vent and at least one electrically insulated structural connector configured to link the cell case with an adjacent battery cell block. Each battery cell block also includes a thermal mitigation barrier (TMB) segment fixed to the cell case and configured to contact the adjacent battery cell block. Each battery cell block additionally includes a thermal insulator configured to line the cell vent. Furthermore, each battery cell block includes a bus bar segment configured to interconnect with a bus bar segment of the adjacent battery cell block.

Each battery cell block may additionally include a cold plate segment configured to interconnect with a cold plate segment of the adjacent battery cell block. The cold plate segment may include a quick-connect device configured to interconnect with the adjacent cold plate segment.

Each battery cell block may additionally include a thermal interface material (TIM) segment arranged between the cold plate segment and the cell case.

The battery cell block may be an edge-positioned battery cell block. The cell case of the edge-positioned battery cell block may be defined by an external shape different from an external cell case shape of the adjacent battery cell block. The edge-positioned battery cell block may incorporate an endplate fixed to the cell case thereof.

The plurality of battery cell blocks may be arranged in one or more battery modules and be mounted to the enclosure tray. In such an embodiment, the modular RESS may further include a mica cover sheet arranged between the enclosure cover and the battery module(s) and fixed to the enclosure cover above the individual thermal insulators.

The RESS may include a plurality of battery modules. In such an embodiment, the modular RESS may further include a mid-plate sandwiched between structural adhesive layers, which are together arranged between neighboring battery modules.

The mid-plate may include an electrically insulating foam element.

The cell case may be configured to be mounted, e.g., fastened, to the enclosure tray.

The RESS enclosure may be part of, i.e., integrated into, a vehicle body structure.

A motor vehicle having a power-source and the above-disclosed modular RESS configured to supply electric energy to the power-source is also disclosed.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a schematic top view of an embodiment of a motor vehicle employing multiple power-sources and a modular multi-cell rechargeable energy storage system (RESS) configured to generate and store electrical energy, according to the present disclosure.

FIG. 2 is a schematic side view of a battery cell array enclosure for the RESS shown in FIG. 1, illustrating the array enclosure having an enclosure tray and an enclosure cover serving as a floor pan section of the vehicle body structure, according to the present disclosure.

FIG. 3 is a schematic exploded perspective view of the RESS shown in FIG. 1, illustrating a plurality of battery cell blocks arranged in individual modules, a mid-plate arranged between neighboring modules and a mica cover sheet.

FIG. 4 is a schematic side view of a single battery cell block shown in FIG. 3, according to the present disclosure.

FIG. 5 is a schematic side view of multiple battery cell blocks interconnected to form the RESS shown in FIGS. 1 and 3, according to the present disclosure.

FIG. 6 is a schematic perspective view of multiple battery cell blocks, including an edge block shown in FIG. 1, according to the present disclosure.

FIG. 7 is a schematic perspective view of one of the battery cell blocks shown in FIG. 1, depicting arrangement of a thermal mitigation barrier (TMB) segment relative to a respective battery cell case, according to the present disclosure.

### DETAILED DESCRIPTION

Those having ordinary skill in the art will recognize that terms such as “above”, “below”, “upward”, “downward”, “top”, “bottom”, “left”, “right”, etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of a number of hardware, software, and/or firmware components configured to perform the specified functions.

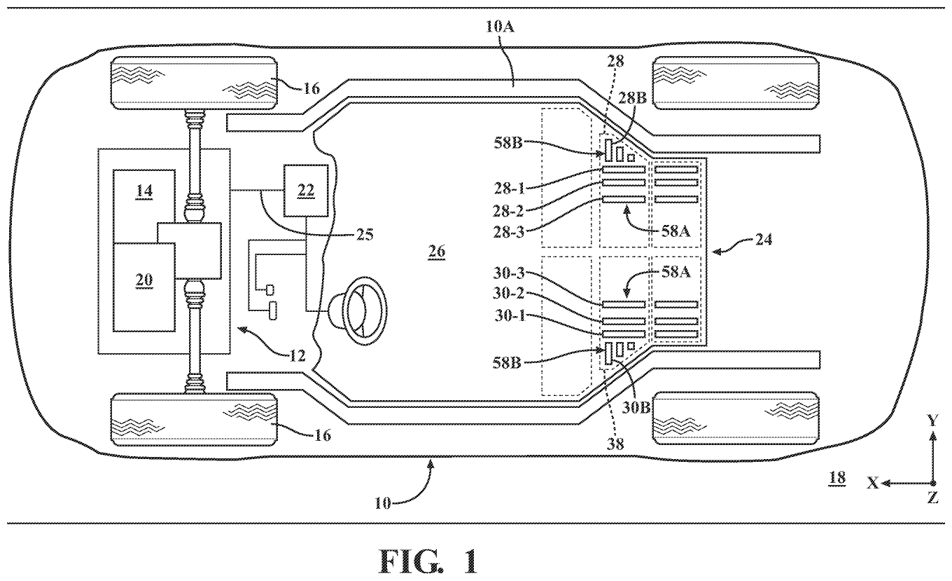

Referring to FIG. 1, a motor vehicle 10 having a powertrain 12 is depicted. The vehicle 10 may include, but not be limited to, a commercial vehicle, industrial vehicle, passenger vehicle, aircraft, watercraft, train or the like. It is also contemplated that the vehicle 10 may be a mobile platform, such as an airplane, all-terrain vehicle (ATV), boat, personal movement apparatus, robot and the like to accomplish the purposes of this disclosure. As shown in FIG. 1, the motor vehicle 10 also includes a vehicle body structure 10A configured to support the powertrain 12 as well vehicle passenger and cargo compartments (not shown). The powertrain 12 includes a power-source 14 configured to generate a power-source torque for propulsion of the vehicle 10 via driven wheels 16 relative to a road surface 18. The power-source 14 is depicted as an electric motor-generator; consequently, the motor vehicle 10 may be identified as an electric vehicle (EV).

As shown in FIG. 1, the powertrain 12 may also include an additional power-source 20, such as an internal combustion engine. The power-sources 14 and 20 may act in concert to power the motor vehicle 10. The motor vehicle 10 additionally includes an electronic controller 22 and a modular multi-cell rechargeable energy storage system (RESS) 24 configured to generate and store electrical energy through heat-producing electro-chemical reactions for supplying the electrical energy to the power-sources 14 and 20. In the instant disclosure, the RESS 24 is defined as “modular” due to the system being constructed from interlocking battery cell blocks, as will be described in detail below. The electronic controller 22 may be a central processing unit (CPU) that regulates various functions of the vehicle 10, or as a powertrain control module (PCM) configured to control the powertrain 12 to generate a predetermined amount of power-source torque.

The modular RESS 24 may be connected to the power-sources 14 and 20, the electronic controller 22, as well as other vehicle systems via a high-voltage BUS 25. Although the RESS 24 is described herein primarily with respect to a motor vehicle environment, nothing precludes the subject RESS from being employed for powering other, non-automotive or stationary systems. The vehicle body structure 10A incorporates the modular RESS 24 as an integral part thereof. As a result, in the motor vehicle 10, the RESS 24 bears at least some structural and/or dynamic loads experienced by the body structure during vehicle operation. The RESS 24 includes one or more sections or arrays 26 of individual battery cells arranged with respect to an X-Y-Z coordinate system. Each battery cell array 26 may be configured as a battery module or a number of battery modules bundled into a battery pack.

With continued reference to FIG. 1, the array 26 includes a plurality of interlocking battery cell blocks, such as a first group of battery cell blocks 28 and a neighboring, directly adjacent, second group of battery cell blocks 30, each extending generally upward, i.e., in the Z direction. Although one array 26 (illustrated as a battery pack) and two groups of battery cell blocks 28, 30 (illustrated as individual modules) are specifically indicated, nothing precludes the RESS 24 from having a greater number of such arrays with a particular number of battery cell blocks arranged therein. As shown, the first cell group 28 includes individual battery cell blocks 28-1, 28-2, 28-3, while the neighboring second cell group 30 includes individual battery cell blocks 30-1, 30-2, 30-3. Individual battery cells in groups 28 and 30 may be prismatic or cylindrically shaped, a.k.a., cylindrical cell blocks.

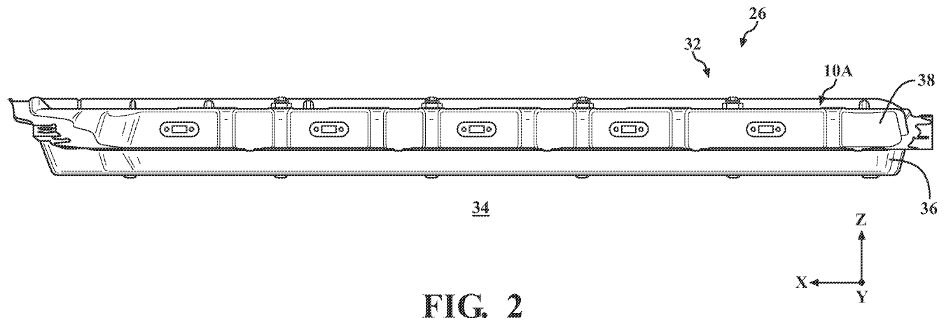

As shown in FIG. 2, the RESS 24 also includes a RESS housing or enclosure 32 configured to accommodate and retain each of the first and second battery cell groups 28, 30. The RESS enclosure 32 is surrounded by an ambient environment 34, i.e., environment external to the RESS enclosure, and configured to bear at least some structural and/or dynamic loads experienced by the vehicle body structure 10A. The RESS enclosure 32 is configured to manage high-temperature gases emitted by battery cells in the cell groups 28, 30, such as during a battery cell thermal runaway event, and expel the high-temperature gases to the external environment 34. The RESS enclosure 32 includes an enclosure tray 36 and an enclosure cover 38. The enclosure cover 38 is generally positioned above the battery cell blocks 28-1, 28-2, 28-3 and 30-1, 30-2, 30-3 and may additionally serve as a floor pan section of the vehicle body structure 10A (shown in FIG. 2).

The enclosure cover 38 is configured to engage the enclosure tray 36 to substantially seal the RESS enclosure 32 and its contents from the external environment 34. As shown in FIG. 2, in the motor vehicle 10, the RESS enclosure 32 is arranged in a horizontal X-Y plane, such that the enclosure cover 38 is positioned above the enclosure tray 36 when viewed along a Z-axis. The battery cell blocks 28-1, 28-2, 28-3, 30-1, 30-2, 30-3 may be arranged parallel to each other in their respective cell groups 28 and 30 within the RESS enclosure 32. Alternatively, some of the battery cell blocks may be arranged perpendicular relative to adjacent cell blocks in the cell array 26 to adapt the general shape of the modular RESS 24 to the space available inside the boundaries of the vehicle body structure 10A.

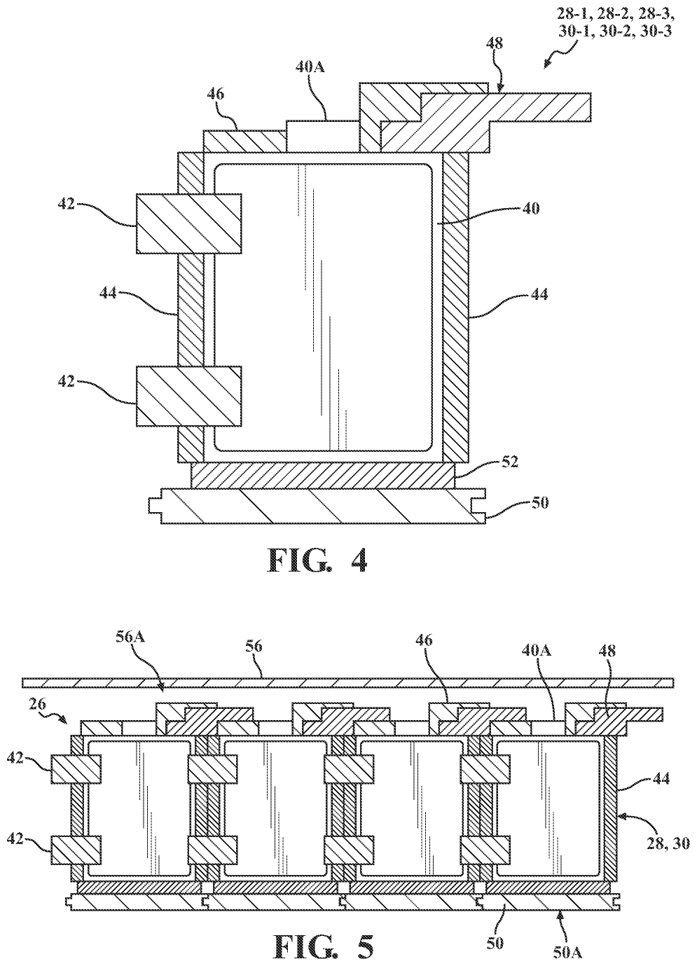

As shown in FIG. 4, each battery cell block 28-1, 28-2, 28-3, 30-1. 30-2, and 30-3 includes a cell case 40 defining a cell vent 40A and enclosing battery cell electrodes, electrolyte, and other related components (not shown). Each interlocking battery cell block in cell groups 28 and 30 also includes one or more electrically insulated structural connectors 42 configured to link or interconnect the cell case 40 with an adjacent battery cell block and enhance structural rigidity of the RESS 24. Each battery cell block 28-1. 28-2, 28-3, 30-1, 30-2, 30-3 additionally includes a thermal mitigation barrier (TMB) segment 44 fixed to the cell case 40. The subject TMB segment 44 is arranged on a particular side of the cell case 40, such that, when the RESS 24 is assembled, the TMB segment is in contact with or pressed against an adjacent battery cell block, and, as a result, at least one TMB segment is sandwiched between a pair of adjacent battery cell blocks.

The TMB segment 44 may be constructed from a specific density foam configured to permit individual neighboring cell blocks in cell groups 28 and 30 to expand and contract while maintaining a predetermined minimum cell contact face pressure. Additionally, although not shown, the array 26 may include an expansion/contraction compensator in addition to the TMB 44, such as different density foam or engineered spring element(s). As shown in FIG. 4, each battery cell block in cell groups 28 and 30 also includes a thermal insulator 46, such as a mica segment, configured to line or cover the cell vent 40A. As shown in FIG. 6, each thermal insulator 46 may cover the entire exposed portion of a respective cell block in cell groups 28 and 30, including the cell vents 40A. In such an embodiment, the thermal insulator 46 may be perforated near or above the cell vent 40A. Alternatively, the thermal insulator 46 may be constructed from separate portions, with individual insulator portions affixed to areas outside the cell vents 40A and additional portions covering the vents (not shown).

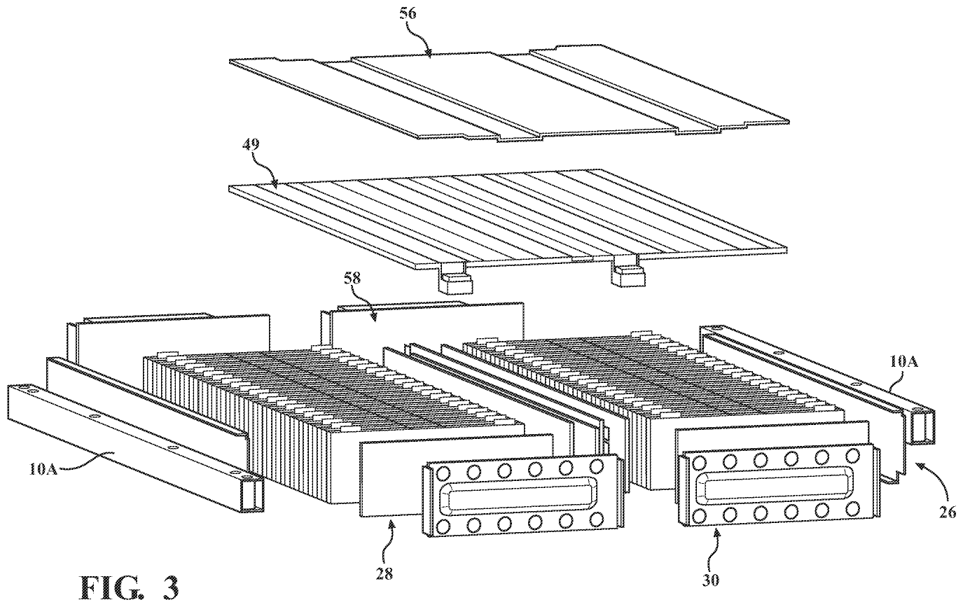

Each battery cell block 28-1, 28-2, 28-3, 30-1, 30-2, 30-3 additionally includes an electrical bussing or bus bar segment 48 configured to interconnect with an analogous bus bar segment of an adjacent battery cell block in the RESS 24. When the battery cell blocks in cell groups 28 and 30 are interconnected, as shown in FIGS. 4 and 5, individual bus bar segments 48 plug into a busbar subassembly 49 (shown in FIG. 3) disposed within the RESS enclosure 32. The busbar subassembly 49 is configured to electrically connect and transmit electrical signals to and from the battery cell blocks in the array 26. The RESS 24 may also include various sensing devices (such as thermistors, fuses, etc.), which, although not specifically shown, are understood to detect operation of cell groups 28, 30 or individual battery cell blocks in the array 26.

Additionally, although not specifically shown, the RESS 24 may include a sensing circuit disposed within the RESS enclosure 32 and electrically connected to the busbar subassembly 48A and the sensing device(s). Such a sensing circuit may be configured to communicate electrical signals from the busbar subassembly 48A and the sensing device(s) to an electronic controller arranged in the external environment 34, such as the electronic controller 22 of the motor vehicle 10. Each battery cell block 28-1. 28-2, 28-3, 30-1, 30-2, 30-3 may additionally include a cold plate segment 50 configured to interconnect with an analogous cold plate segment of an adjacent battery cell block in the array 26. The cold plate segment 50 may include a quick-connect device 51 configured to facilitate a reliable, fluid-tight, i.e., sealed, attachment of the cold plate segment 50 to the cold plate segment of an adjacent battery cell block. For example, the quick-connect device 51 may be a push-on type with one connector having a moveable/releasable collet fixed to a pipe or tube of one cold plate segment and configured to engage and lock onto a mating connector fixed to an adjacent cold plate segment pipe, and a sealing O-ring in between. On the battery cell array 26 level, the cold plate segments 50 are in fluid communication with a coolant manifold (not shown).

When the battery cell blocks in cell groups 28 and 30 are interconnected, as shown in FIGS. 3 and 5, the cold plate segments 50 of the constituent battery cell blocks form a cold plate subassembly 50A. The resultant cold plate subassembly 50A is generally positioned below (or, although not shown, between) the subject battery cell blocks to thereby absorb thermal energy therefrom and maintain requisite RESS 24 operating conditions. Each battery cell block in cell groups 28 and 30 may further include a thermal interface material (TIM) segment 52 arranged between the cold plate segment 50 and the cell case 40, e.g., the enclosure tray 36. Each of the interlocking blocks battery cell blocks 28-1, 28-2, 28-3, 30-1, 30-2, 30-3 may be mounted to the enclosure tray 36, for example by one or more fasteners 54.

With reference to FIG. 5, the modular RESS 24 may also include a mica cover sheet 56 arranged between the enclosure cover 38 and the battery cell array 26 having one or more modules. The mica cover sheet 56 may be fixed to the enclosure cover 38 above the individual thermal insulators 46, thereby defining a channel 56A (shown in FIG. 5) for battery cell gases emitted by individual battery cell blocks via the respective vents 40A. As shown in FIG. 3, the modular RESS 24 may also include a mid-plate 58 sandwiched between structural adhesive layers 60. The mid-plate 58 may include an electrically insulating foam element 58A. Together, the mid-plate 58 with the structural adhesive layers 60 may be arranged between neighboring groups, e.g., 28 and 30, or modules of the battery cell array 26, thereby providing thermal and electrical isolation therebetween. In the event of a thermal runaway in one of the battery cell modules or arrays, the mid-plate 58 is intended to protect a neighboring battery module from succumbing to the same.

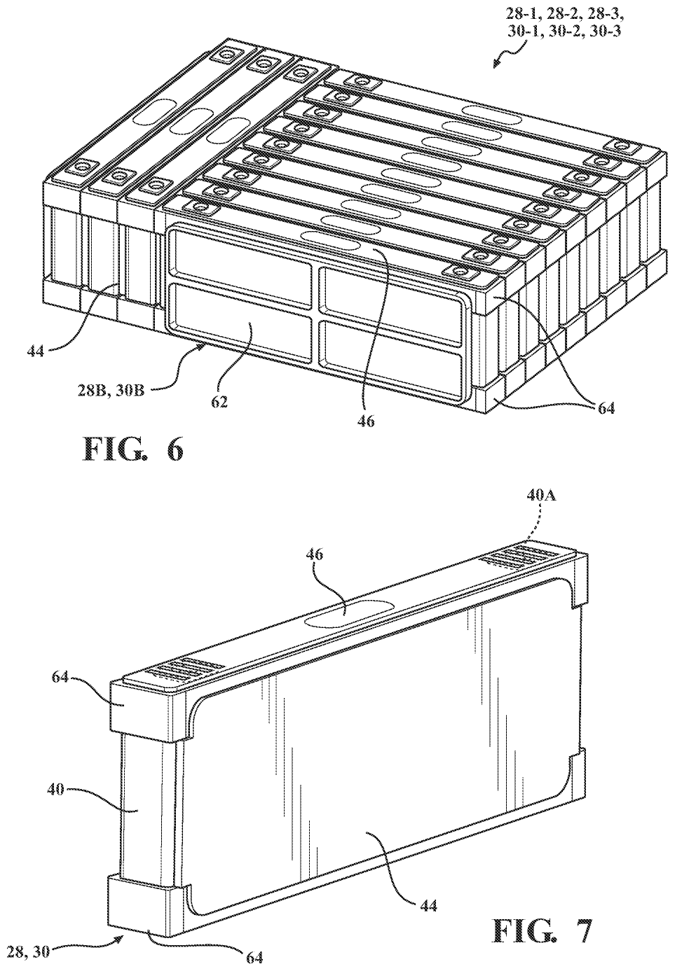

With resumed reference to FIG. 1, in the RESS 24, cell cases 40 of majority of the battery cell blocks, such as the blocks 28-1. 28-2, 28-3, 30-1. 30-2, 30-3 are defined by a common external shape 58A, permitting case of modular RESS assembly. Some of the battery cell blocks in the RESS 24 may be “edge-positioned”, i.e., located next to substantially vertical side walls of the RESS enclosure 32, which may, for example, be generated by the enclosure tray 36 and/or the enclosure cover 38. Such edge-positioned battery cell blocks are specifically identified in FIG. 1 by numerals 28B and 30B. Each of the respective cell cases 40 of the edge-positioned battery cell blocks 28B and 30B may be defined by an external shape 58B that is different from an external shape 58A of adjacent and majority of the battery cell block cases in the RESS 24. As shown in FIGS. 1 and 6, the edge-positioned battery cell blocks 28B and 30B may be arranged at an angle, e.g., perpendicular, relative to adjacent cell blocks in the corresponding cell array 26. Each of the cells blocks 28B, 30B positioned on the edge of the array 26 may incorporate an endplate (or plate like) element 62 rigidly affixed to a structural framing component 64 of the cell block (shown in FIG. 6). As shown in FIG. 5, one structural framing component 64 may be fixed to the top of the respective cell case 40 and another to its bottom, such as via a weld, a crimped edge, an adhesive, bolts, rivets, etc. As shown in FIG. 7, an individual TMB segment 44 may be arranged against the cell case 40, between the endplate 62 and the respective cell block 28B, 30B, permitting the subject cell block to expand and contract while maintaining the prescribed cell face pressure.

The difference between the external shape of majority of the battery cell blocks and the external shape of edge-positioned blocks 28B, 30B facilitates modular construction and more effective customization or adaptation of the RESS 24 to an existing vehicle body structure 10A having particular configuration or contours of frame rails, passenger compartment floor, etc. The size and shape of the RESS 24 may be specifically adapted to the motor vehicle 10 structure in the X-Y plane, i.e., viewing the motor vehicle 10 structure in a plan view, as shown in FIG. 1. The resultant adaptation of the modular RESS 24 may permit packaging an increased number of battery cell blocks therein. Such construction of the RESS 24 enables more effective utilization of available space within the vehicle body structure 10A, and in turn enhances RESS charging capacity and available operating range of the motor vehicle 10.

In summary, the modularly connected and interlocked battery cell blocks, such as the blocks 28-1, 28-2, 28-3, 30-1, 30-2, 30-3, provide a design-flexible RESS 24 that may be adapted to its host environment, while maximizing available packaging space. Each of the interlocked battery cell blocks includes a thermal mitigation barrier (TMB) segment and a thermal insulator configured to line the cell vent and isolate the cell in the event of a thermal runaway. Also, each battery cell block includes a bus bar segment configured to interconnect with neighboring bus bar segments to generate a RESS busbar subassembly. Each interlocked battery cell block may also include a cold plate segment that interconnects with an adjacent battery cell block cold plate segment to form a RESS cold plate subassembly. The interlocked battery cell blocks provide the modular RESS 24 with enhanced rigidity, which may be useful when the RESS is incorporated into its host environment, such as a vehicle body structure.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework of the scope of the appended claims.

What is claimed is:

1. A modular multi-cell rechargeable energy storage system (RESS) comprising:
a RESS enclosure surrounded by an external environment and having an enclosure tray and an enclosure cover; and
a plurality of battery cell blocks arranged in the RESS enclosure, wherein each battery cell block includes:
a cell case including a cell vent and at least one electrically insulated structural connector configured to link the cell case with an adjacent battery cell block;
a thermal mitigation barrier (TMB) segment fixed to the cell case and configured to contact the adjacent battery cell block;
a thermal insulator configured to line the cell vent; and
a bus bar segment configured to interconnect with a bus bar segment of the adjacent battery cell block.

2. The modular RESS of claim 1, wherein each battery cell block additionally includes a cold plate segment configured to interconnect with a cold plate segment of the adjacent battery cell block.

3. The modular RESS of claim 2, wherein each battery cell block additionally includes a thermal interface material (TIM) segment arranged between the cold plate segment and the cell case.

4. The modular RESS of claim 1, wherein the battery cell block is an edge-positioned battery cell block incorporating an endplate fixed to the cell case of the edge-positioned battery cell block.

5. The modular RESS of claim 1, wherein the plurality of battery cell blocks is arranged in one or more battery modules and mounted to the enclosure tray, the modular RESS further comprising a mica cover sheet arranged between the enclosure cover and the one or more battery modules and fixed to the enclosure cover.

6. The modular RESS of claim 5, wherein the one or more battery modules includes a plurality of battery modules, the modular RESS further comprising a mid-plate sandwiched between structural adhesive layers and together arranged between neighboring battery modules.

7. The modular RESS of claim 6, wherein the mid-plate includes an electrically insulating foam element.

8. The modular RESS of claim 1, wherein the cell case is configured to be mounted to the enclosure tray.

9. The modular RESS of claim 1, wherein the RESS enclosure is part of a vehicle body structure.

10. A motor vehicle comprising:
a power-source configured to generate power-source torque;
a vehicle body structure incorporating, as part thereof, a modular multi-cell rechargeable energy storage system (RESS) configured to supply electrical energy to the power-source, the modular RESS including:
a RESS enclosure surrounded by an external environment and having an enclosure tray and an enclosure cover; and
a plurality of battery cell blocks arranged in the RESS enclosure, wherein each battery cell block includes:
a cell case including a cell vent and at least one electrically insulated structural connector configured to link the cell case with an adjacent battery cell block;
a thermal mitigation barrier (TMB) segment fixed to the cell case and configured to contact the adjacent battery cell block;
a thermal insulator configured to line the cell vent; and
a bus bar segment configured to interconnect with a bus bar segment of the adjacent battery cell block.

11. The motor vehicle of claim 10, wherein each battery cell block additionally includes a cold plate segment configured to interconnect with a cold plate segment of the adjacent battery cell block.

12. The motor vehicle of claim 11, wherein each battery cell block additionally includes a thermal interface material (TIM) segment arranged between the cold plate segment and the cell case.

13. The motor vehicle of claim 10, wherein the battery cell block is an edge-positioned battery cell block incorporating an endplate fixed to the cell case of the edge-positioned battery cell block.

14. The motor vehicle of claim 10, wherein the plurality of battery cell blocks is arranged in one or more battery modules and mounted to the enclosure tray, the modular RESS further comprising a mica cover sheet arranged between the enclosure cover and the one or more battery modules and fixed to the enclosure cover.

15. The motor vehicle of claim 14, wherein the one or more battery modules includes a plurality of battery modules, the modular RESS further comprising a mid-plate sandwiched between structural adhesive layers and together arranged between neighboring battery modules.

16. The motor vehicle of claim 15, wherein the mid-plate includes an electrically insulating foam element.

17. The motor vehicle of claim 10, wherein the cell case is configured to be mounted to the enclosure tray.

18. The motor vehicle of claim 10, wherein the RESS enclosure is part of a vehicle body structure.

19. A battery cell block for a modular multi-cell rechargeable energy storage system (RESS), the battery cell block comprising:
a cell case including a cell vent and at least one electrically insulated structural connector configured to link the cell case with an adjacent battery cell block in the modular RESS;
a thermal mitigation barrier (TMB) segment fixed to the cell case and configured to contact the adjacent battery cell block;
a thermal insulator configured to line the cell vent;
a bus bar segment configured to interconnect with a bus bar segment of the adjacent battery cell block; and
a cold plate segment configured to interconnect with a cold plate segment of the adjacent battery cell block.

20. The battery cell block of claim 19, further comprising a thermal interface material (TIM) segment arranged between the cold plate segment and the cell case.
